(19) United States
(12) Patent Application Publication
(10) Pub. No.: US 2021/0271031 A1
(43) Pub. Date: Sep. 2, 2021

(54) APPARATUS FOR PROCESSING A FERRULE AND ASSOCIATED METHOD

(71) Applicant: CORNING RESEARCH & DEVELOPMENT CORPORATION, Corning, NY (US)

(72) Inventor: Cameron John Tovey, Painted Post, NY (US)

(21) Appl. No.: 17/323,281

(22) Filed: May 18, 2021

Related U.S. Application Data
(63) Continuation of application No. PCT/US2019/060435, filed on Nov. 8, 2019.
(60) Provisional application No. 62/771,317, filed on Nov. 26, 2018.

(51) Int. Cl. G02B 6/38; G02B 6/40

(52) U.S. Cl. CPC G02B 6/3833; G02B 6/3882; G02B 6/403

(57) ABSTRACT

An apparatus for processing a ferrule with an abrasive element. The apparatus includes a first mount configured to secure the ferrule. A second mount includes a holding plate configured to secure the abrasive element. A controller is operatively coupled to the second mount for controlling the movement of the holding plate. The second mount includes a non-stacked multi-axis frame for moving the holding plate within a plane. The multi-axis frame includes a first stage movable along a first axis and a second stage movable along a second axis, wherein the first and second axes are substantially parallel to each other but provide for two-dimensional movement of the holding plate within the plane. A method of processing a ferrule is also disclosed.

### PRIORITY APPLICATION

This application is a continuation of International Application No. PCT/US19/60435, filed on Nov. 8, 2019, which claims the benefit of priority to U.S. Application No. 62/771,317, filed on Nov. 26, 2018, both applications being incorporated herein by reference.

### TECHNICAL FIELD

This disclosure relates generally to optical connectivity, and more particularly to an apparatus for processing a ferrule for optical fiber applications and an associated method for processing ferrules.

### BACKGROUND

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, fiber optic connectors are often provided on the ends of fiber optic cables. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” fiber optic connector).

Regardless of where installation occurs, a fiber optic connector typically includes a ferrule with one or more bores that receive one or more optical fibers. The ferrule supports and positions the optical fiber(s) with respect to a housing of the fiber optic connector. Thus, when the housing of the fiber optic connector is mated with another connector (e.g., in an adapter), an optical fiber in the ferrule is positioned in a known, fixed location relative to the housing. This allows an optical connection to be established when the optical fiber is aligned with another optical fiber provided in the mating connector.

The assembly of connectors involve several steps, including the end preparation of the optical fibers to be connectorized. In general, end preparation involves four main processing steps: (1) stripping the polymer coating to expose a select length of the bare glass fiber; (2) precision cleaving the base glass fiber section with controlled end angles and surface quality; (3) inserting the optical fiber in a ferrule of the connector to have a controlled protrusion distance from the ferrule; and (4) polishing the end of the optical fiber that protrudes from the ferrule. The precision cleaving step may take place before or after inserting the optical fiber in the ferrule. The polishing step aids in removing certain defects from the end face of the optical fiber as well as the end face of the ferrule, such as scratches, pits, digs, as well as adhesives and contaminates, to provide a clean, well-defined mating interface.

The fiber and ferrule end faces are generally flush with each other and in many cases the ferrule end face has a domed geometry with the dome apex intended to be at the center of the optical fiber. Such domed geometry is often referred to as a “physical contact” geometry, and it may be a result of polishing the end face of the ferrule prior to inserting the optical fiber, polishing fiber and ferrule end faces together (e.g., after inserting the optical fiber into the ferrule and securing it relative to the ferrule), or some combination of these approaches. The ferrule, for example, may be polished from every direction equally so that the end face of the ferrule generally has the domed geometry before inserting the optical fiber.

Regardless of the approach, it is important that the polishing step of the connectorization process maintains/achieves the desired precise geometry of the ferrule/fiber end faces. Indeed, in many cases, the fiber and ferrule end faces must conform to relevant industry standards that specify requirements for apex offset (AO), radius of curvature (ROC), and fiber height for different physical contact geometries. Examples of physical contact geometries known in the industry include, but are not limited to, physical contact (PC), angled physical contact (APC), and ultra physical contact (UPC) geometries. Thus, the challenge is to polish down the protrusion of the optical fiber from the ferrule end face to an acceptable height (e.g., within 50 microns of the ferrule end face) and to polish out defects in the optical fiber and ferrule in a manner that does not alter the end face geometries (e.g., the radius of curvature in the case of a domed end face) or the position of the apex. In conventional approaches, this is achieved by engaging the ferrule/fiber end faces with an abrasive element, which may take the form of an abrasive sheet or film, or an abrasive slurry. In order to maintain the end face geometry during the polishing step, it is desirable to polish the ferrule/fiber end faces equally from every direction.

Several approaches have been developed to ensure that polishing occurs equally from every direction. These approaches typically include moving the ferrule/fiber assembly relative to the abrasive element in a certain pattern. By way of example, a circular pattern is often used to polish the ferrule/fiber end faces. Thus, for example, if the abrasive element is fixed in position and the ferrule/fiber assembly is moved along a circular path, then the direction of polish, which is tangent to the circular motion, goes through every direction equally and the geometry of the ferrule/fiber end faces is maintained. A figure-8 polishing pattern may also be used to polish the ferrule/fiber end faces equally from every direction and thereby maintain precise end face geometry. In this regard, a polishing apparatus may be configured to fix the ferrule/fiber assembly and then provide the abrasive element on a platen that is movable within a plane (e.g., an x-y plane), such as by a suitable frame having an x-stage and y-stage for moving the platen in two orthogonal directions. By way of example, U.S. Pat. No. 5,947,797 discloses such a polishing apparatus for producing a figure-8 trace pattern in an abrasive element.

While such apparatuses are generally suitable for their intended purpose, certain shortcomings do exist. For example, one shortcoming of existing polishing apparatuses is the speed at which the ferrule/fiber assemblies may be processed. More particularly, from a manufacturing standpoint, it is desirable to polish the ferrule/fiber assemblies as quickly as possible to maximize the production rate of the polished components. The speed at which the ferrule/fiber assemblies may be processed may be limited by the speed at which the platen (which carries the abrasive element) may be moved within the x-y plane to generate the desired trace pattern on the abrasive element. The movement in the x-y plane may be achieved by suitable motors or actuators associated with the x and y stages.

Current apparatuses typically stack the x and y stages one on top of the other in order to provide the desired movement within the x-y plane. Thus, the mass associated with one of the stages (e.g., the y-stage) is carried or supported by the other stage (e.g., the x-stage). To move the platen at a relatively high rate of speed requires that the motors be relatively large and capable of generating the necessary forces to achieve the desired motion. However, the large mass associated with the platen and stages, and especially the one stage that is supporting the other stage, and the speeds at which it is desired to move the platen within the x-y plane results in a dynamic system that is subject to vibrations (e.g., from weight imbalances) and other dynamic effects. As the speed is increased, a value may be reached at which the apparatus starts to vibrate, shake, knock or rattle and these disturbances will likely increase in amplitude with a further increase in speed. Of course, these vibrations have a negative impact of the quality of the polish and this effectively operates as a practical limit on how fast the ferrule/fiber assemblies may be processed by the apparatus.

Attempts have been made to address the vibrations associated with the moving platen to exceed this practical limit in processing speed. For example, one approach is to use various counterbalance measures, such as counter weights, that when included in the dynamic system, minimize the vibrations as the processing speeds increase. Such counterbalance measures, however, are expensive and often provide limited effectiveness and improvement to the production rates.

### SUMMARY

An apparatus for processing a ferrule with an abrasive element includes a first mount configured to secure the ferrule and a second mount that includes a holding plate configured to secure the abrasive element. The second mount also includes a multi-axis frame supporting the holding plate and configured to move the holding plate within a plane. A controller is operatively coupled to the multi-axis frame for controlling the movement of the holding plate. The multi-axis frame comprises a first stage movable along a first axis and a second stage movable along a second axis that is substantially parallel to the first axis. Thus, while the first and second stages move along substantially parallel axes, two-dimensional movement of the holding plate within the plane may be achieved. Axes are “substantially parallel” or “generally parallel” in this disclosure when they are seen as parallel or approximately parallel, such as being angled less than 2 degrees from each other in a plane in which the axes are located or on which the axes are superimposed.

In an exemplary embodiment, the multi-axis frame is configured to have a “non-stacked” configuration, wherein the first and second stages are movably coupled to a base of the multi-axis frame independently from each other. Neither one of first stage and the second stage supports mass of the one of the first stage and second stage. In one embodiment, the first and second stages may be laterally offset from each other so there is no overlap between the two stages. Additionally, support for the holding plate may be shared between the first and second stages such that neither stage supports the entire mass of the holding plate. This arrangement allows each stage to carry a lower mass, thus allowing the holding plate to move at higher speeds without the associated vibrations. Higher production rates may then be attained.

In an exemplary embodiment, the multi-axis frame may be configured such that movement of the first and second stages in a same direction along their respective first and second axes causes the holding plate to move in a first direction within the plane, and movement of the first and second stages in opposite directions along their respective first and second axes causes the holding plate to move in a second direction within the plane. The second direction is different than the first direction. In one embodiment, the first direction may be generally parallel to the first and second axes along which the first and second stages traverse. Moreover, the second direction may be substantially perpendicular to the first direction. Directions are “substantially perpendicular” or “generally perpendicular” in this disclosure when they are seen as perpendicular or approximately perpendicular, such as being angled at 88-92 degrees from each other in a plane in which directions are superimposed. Alternatively, the second direction may not be substantially perpendicular to the first direction, but at a minimum the second direction may include a component that is substantially perpendicular to the first direction. In one embodiment, the first and second axes may be laterally spaced from each other. In an alternative embodiment, however, the first and second axes may be substantially colinear with each other (i.e., extending along a common line or being angled less than 2 degrees from a common line).

In an exemplary embodiment, the multi-axis frame further includes a base, wherein the first stage is movably coupled to the base by one or more first stage guide rails, and the second stage is movably coupled to the base by one or more second stage guide rails. The one or more first stage guide rails may extend in a direction substantially parallel to the first axis, and the one or more second stage guide rails may extend in a direction substantially parallel to the second axis. The one or more first stage guide rails and the one or more second stage guide rails may be laterally spaced from each other. Alternatively, the one or more first stage guide rails and the one or more second stage guide rails may be colinear with each other and collectively form a corresponding one or more continuous guide rails. In other words, each colinear guide rail pair may form a continuous guide rail.

In an exemplary embodiment, the holding plate may be movably coupled to the first stage by one or more first holding plate guide rails, and may be further movably coupled to the second stage by one or more second holding plate guide rails. The one or more first holding plate guide rails coupling the holding plate to the first stage may be arranged at a first angle relative to the first axis. In a similar manner, the one or more second holding plate guide rails coupling the holding plate to the second stage may be arranged at a second angle relative to the second axis. In one embodiment, the first angle and the second angle may be substantially equal (i.e., within 2%). For example, the first and second angles may be substantially equal to about 45 degrees. In an alternative embodiment, however, the first angle and the second angle may be different from each other.

In an exemplary embodiment, the first mount may be stationary. In one embodiment, the holding plate may further include a rotatable spindle, wherein the abrasive element is configured to be secured to the spindle. The multi-axis frame then moves the rotating spindle within the plane. The controller is configured to cause relative movement between the first and second mounts such that engagement of the ferrule with the abrasive element during the relative movement traces an abrasion path in the abrasive element. The path may be selected from the group consisting of a circle, figure-8, or a spiral. In one embodiment, a ferrule assembly includes the ferrule and at least one optical fiber coupled to the ferrule, and the apparatus may be configured for processing the ferrule assembly with the abrasive element.

A method of processing a ferrule that includes an end face is also provided. The method includes holding the ferrule stationary, engaging the end face of the ferrule with the abrasive element, and moving the abrasive element relative to the ferrule within a plane to trace an abrading path on the abrasive element. The abrasive element is coupled to a multi-axis frame that includes a first stage and a second stage. The moving step further includes moving the first stage along a first axis and moving the second stage along a second axis parallel to the first axis to move the abrasive element relative to the ferrule within the plane. This arrangement allows each stage to carry a lower mass, thus allowing the abrasive element to move at higher speeds without the associated vibrations. Higher production rates may then be attained.

In one embodiment, the moving steps may include moving the first and second stages along their respective first and second axes in a same direction to move the abrasive element in a first direction. More particularly, moving the first and second stages along their respective axes in a same direction may move the abrasive element in a first direction substantially parallel to the first and second axes. Additionally, the moving steps may include moving the first and second stages along their respective axes in opposite directions to move the abrasive element in a second direction, wherein the second direction is different than the first direction. In one embodiment, moving the first and second stages along their respective axes in opposite directions may move the abrasive element in a second direction substantially perpendicular to the first direction.

In yet a further embodiment, the abrasive element may be rotated about a central axis during movement of the abrasive element within the plane using the multi-axis frame. For example, a spindle may be provided on the multi-axis frame for rotating the abrasive element as the abrasive element is moved within the plane. In one embodiment, the abrasive element is moved relative to the ferrule to trace an abrasion path on the abrasive element. The abrasion path may be configured as a circular path, a figure-8 path, or a spiral path due to the relative movement between the ferrule and the abrasive element. In a further embodiment, a ferrule assembly includes the ferrule and at least one optical fiber coupled to the ferrule, and wherein the engaging and moving are performed with the ferrule assembly.

An apparatus for processing a workpiece includes a multi-axis frame for moving the workpiece within a plane. The multi-axis frame includes a base, a first stage coupled to the base and movable along a first axis, and a second stage coupled to the base and movable along a second axis, wherein the first and second axes are substantially parallel to each other. In an exemplary embodiment, the multi-axis frame is configured to have a “non-stacked” configuration, wherein the first and second stages are coupled to the base independently from each other. Additionally, a holding plate may be movably coupled to each of the first and second stages. Movement of the first and second stages in a same direction along their respective first and second axes causes the workpiece to move in a first direction within the plane, and movement of the first and second stages in opposite directions along their respective first and second axes causes the workpiece to move in a second direction within the plane. The second direction is different than the first direction. In one embodiment, the first direction may be generally parallel to the first and second axes. Moreover, the second direction may be substantially perpendicular to the first direction.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective view of a fiber optic connector;

FIG. 2 is an exploded perspective view of the fiber optic connector shown in FIG. 1;

FIG. 3 is a cross-sectional view of the fiber optic connector of FIG. 1 installed on a fiber optic cable;

FIGS. 4A and 4B schematically illustrate a ferrule and optical fiber coupled together and being polished by an abrasive element at a mating interface;

FIG. 5 schematically illustrates an apparatus for moving a ferrule assembly relative to an abrasive element and having a stacked multi-axis frame;

FIG. 6 schematically illustrates an apparatus for moving a ferrule assembly relative to an abrasive element and having a non-stacked multi-axis frame in accordance with one embodiment of the disclosure;

FIGS. 7A-7C are schematic illustrations of the movement of the abrasive element within a plane and in a first direction using the multi-axis frame;

FIGS. 8A-8C are schematic illustrations of the movement of the abrasive element within a plane and in a second direction using the multi-axis frame;

FIGS. 9A-9C are schematic illustrations of the movement of the abrasive element within a plane and in a first direction using a multi-axis frame in accordance with another embodiment of the disclosure;

FIGS. 10A-10C are schematic illustrations of the movement of the abrasive element within a plane and in a second direction using the multi-axis frame of FIGS. 9A-9C;

FIG. 11 is a schematic illustration for mapping the movement of the abrasive element from a first domain to a second domain; and

FIG. 12 schematically illustrates an apparatus for moving a ferrule assembly relative to an abrasive element and having a non-stacked multi-axis frame in accordance with another embodiment of the disclosure.

### DETAILED DESCRIPTION

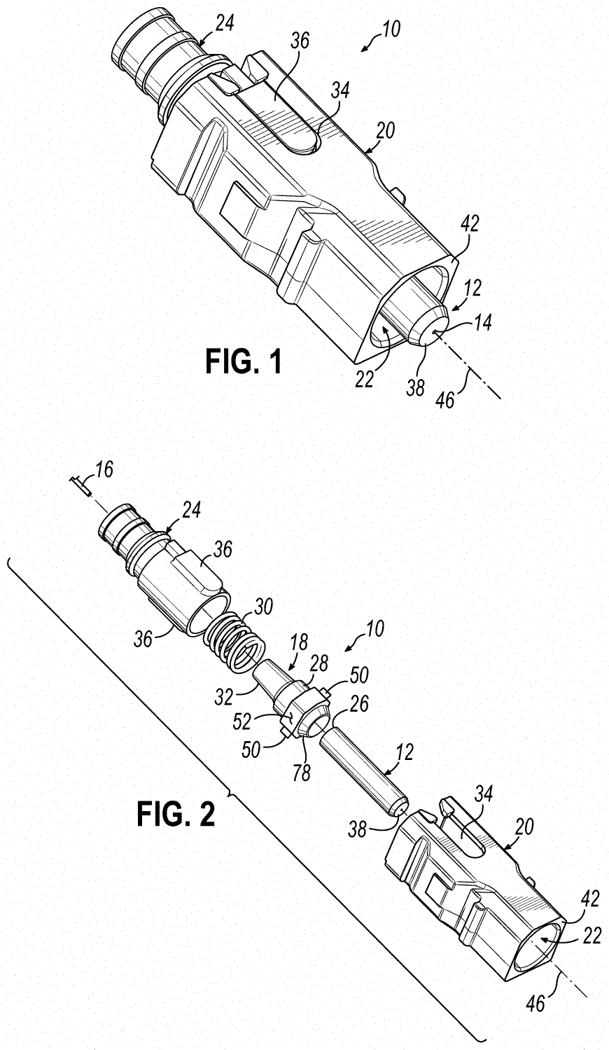

Various embodiments will be further clarified by examples in the description below. In general, the description relates to processing ferrules, such as those used in fiber optic connectors and fiber optic cable assemblies including the same. One example of a fiber optic connector 10 (also referred to as “optical connector 10”, or simply “connector 10”) is shown in FIG. 1. Although the connector 10 is shown in the form of a SC-type connector, the features described below may be applicable to different connector designs. This includes ST, LC, and MU-type connectors, for example, and other single-fiber or multi-fiber connector designs.

As shown in FIGS. 1 and 2, the connector 10 includes a ferrule 12 having a ferrule bore 14 (“micro-hole”) configured to support an optical fiber 16, a ferrule holder 18 from which the ferrule 12 extends, a housing 20 having a cavity 22 in which the ferrule holder 18 is received, and a connector body 24 (also referred to “retention body 24” or “crimp body 24”) configured to retain the ferrule holder 18 within the housing 20. More specifically, a back end 26 of the ferrule 12 is received in a first portion 28 of the ferrule holder 18 and is secured therein in a known manner (e.g., press-fit, adhesive, molding the ferrule holder 18 over the back end 26 of the ferrule 12, etc.). The ferrule 12 and ferrule holder 18 may even be a monolithic structure in some embodiments.

The ferrule holder 18 is biased to a forward position within the housing 20 by a spring 30, which extends over a second portion 32 of the ferrule holder 18 that has a reduced cross-sectional diameter/width compared to the first portion 28. The spring 30 also interacts with internal geometry of the connector body 24, which may be secured to the housing 20 using a snap-fit or the like. For example, FIGS. 1 and 2 illustrate a rear portion of the housing 20 having cut-outs or slots 34 on opposite sides so as to define a split shroud. The connector body 24 has tabs 36 configured to be snapped into the slots 34 and retained therein due to the geometries of the components.

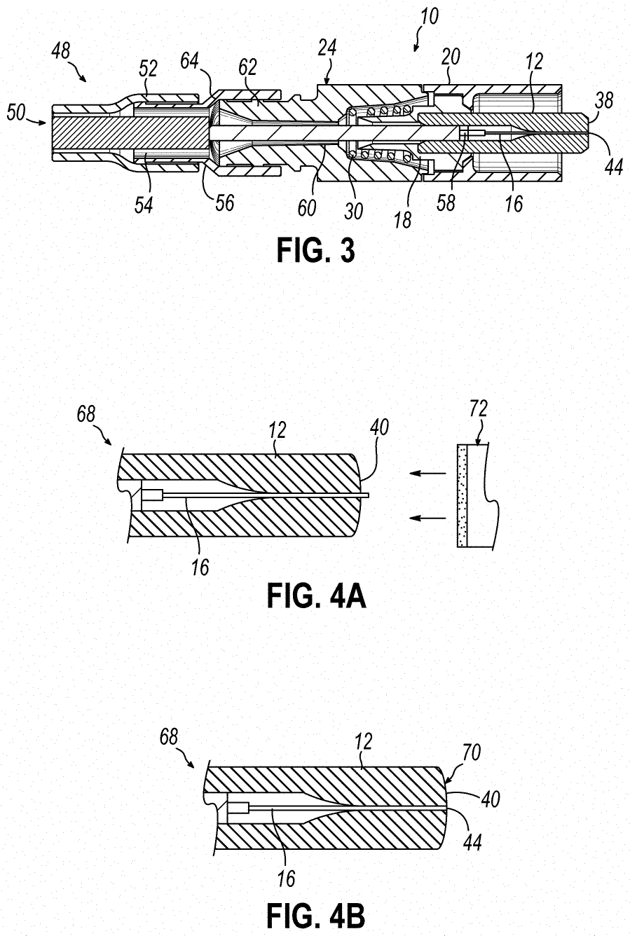

When the connector 10 is assembled as shown in FIG. 1, a front end 38 of the ferrule 12 (“ferrule end face 40”) projects beyond a front end 42 of the housing 20. The ferrule end face 40 presents the optical fiber 16 (“fiber end 44”) for optical coupling with a mating component (e.g., another fiber optic connector; not shown). Note that the ferrule 12 aligns the optical fiber 16 along a longitudinal axis 46. These aspects can be better appreciated with reference to FIG. 3, which shows how a fiber optic cable 48 (hereinafter “cable 48”) including the optical fiber 16 can be terminated with the connector 10. In other words, the connector 10 can be installed on the cable 48 to form a fiber optic cable assembly 50. The cable 48 is merely an example to facilitate discussion. In the embodiment shown, the fiber cable 48 includes an outer jacket 52, inner jacket 54, strength members 56 in the form of aramid yarn, and the optical fiber 16, which itself has a coating 58 and a buffer layer 60 (“tight buffer”). Portions of the outer jacket 52 and inner jacket 54 have been removed from the optical fiber 16 to expose the strength members 56, which are cut to a desired length and placed over a rear portion 62 of the connector body 24. The strength members 56 are coupled to the connector body 24 by a crimp band 64 (also referred to as “crimp ring”) that has been positioned over the optical fiber 16 and a portion of the strength members 56 and inner jacket 54. Again, the cable 48 is merely an example, as persons skilled in optical connectivity will appreciate how different cable designs may be terminated with the connector 10.

During the formation of the connector 10, the optical fiber 16 may be coupled to the ferrule 12 (e.g., secured to the ferrule bore 14 using an adhesive) in the connectorization process to provide a ferrule assembly 68. As used herein and illustrated in FIGS. 4A and 4B, a ferrule assembly 68 includes the ferrule 12 and the optical fiber 16 coupled together. The ferrule end face 40 and a front end of the optical fiber 16 (“fiber end 44”) together define a mating interface 70 (“interface 70”). In one embodiment, the mating interface 70 may be generally domed shaped with the optical fiber 16 positioned at or substantially at (i.e., within 50 microns of) the apex of the dome. Other geometries, however, may also be possible. During the connectorization process the optical fiber 16 may have a small protrusion that extends beyond the ferrule end face 40 (FIG. 4A). The interface 70 is then polished with an abrasive element 72 to remove the protrusion so that the fiber end 44 is substantially flush with (i.e., within 50 microns of) the ferrule end face 40 (FIG. 4B). Additionally, polishing also helps remove adhesive and defects that may exist on the interface 70.

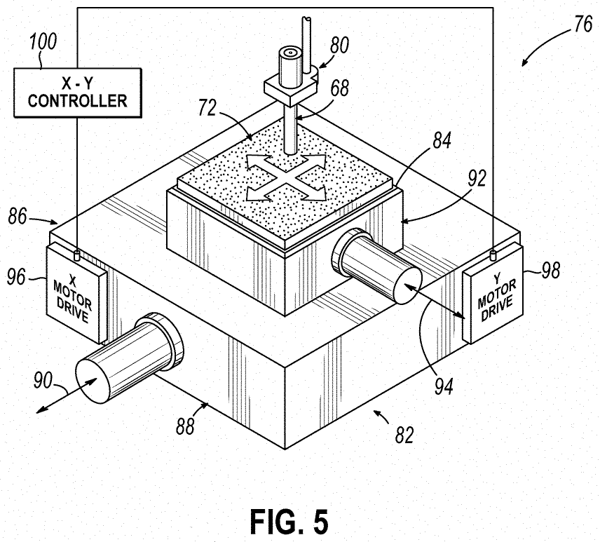

FIG. 5. illustrates an apparatus 76 for generating the relative movement between the ferrule assembly 68 and the abrasive element 72 to generate an abrasion path 78 (e.g., circle, figure-8, spiral, etc.) on the abrasive element 72. As mentioned above, the ferrule 12 may be processed by itself (i.e., before inserting and securing the optical fiber 16) and/or as part of the ferrule assembly 68 (i.e., after inserting and securing the optical fiber 16 in the ferrule 12). Thus, although the apparatus 76 as well as the other apparatuses discussed below are described with reference to processing the ferrule assembly 68, the disclosure may apply equally to situations where the ferrule 12 is at least partially processed separately from the optical fiber.

The apparatus 76 may be configured such that the ferrule assembly 68 is stationary while the abrasive element 72 is moved in an x-y plane to generate the abrasion path 78. In the embodiment shown, the ferrule assembly 68 is secured to a first mount 80 and the abrasive element 72 is secured to a second mount 82. The second mount 82 includes a holding plate or platen 84 having an upper surface configured to receive the abrasive element 72, which may take the form of an abrasive sheet or film. The second mount 82 is configured to be movable. In this regard, the holding plate 84 may be mounted to a multi-axis frame 86 having an x-stage 88 for moving the holding plate 84 in a direction defined by an x-axis 90 and a y-stage 92 for moving the holding plate 84 in a direction defined by a y-axis 94. The x-stage 88 includes a motor drive 96 for controlling an actuator (not shown) for moving the x-stage 88 along the x-axis 90 (i.e., in an x-direction). The y-stage 92 similarly includes a motor drive 98 for controlling an actuator for moving the y-stage 92 along the y-axis 94 (i.e., in a y-direction). The apparatus 76 thus provides for two degrees of freedom for moving the abrasive element 72 in the x-y plane in order to polish the mating interface 70 of the ferrule assembly 68 with the abrasive element 72. The motor drives 96, 98 may be operatively coupled to a controller 100 for controlling the position of the abrasive element 72 relative to the ferrule assembly 68.

As clearly demonstrated in FIG. 5, the mass associated with the abrasive element 72, the holding plate 84, and the y-stage 92 is supported by the x-stage 88, thus demonstrating a “stacked” configuration of the stages 88, 92 to provide movement within the x-y plane. As discussed above, this type of arrangement has a practical limitation in production rates due to the inability to move large masses, such as that associated with the x-stage 88, at a high rate of speed and without vibrations. In order to overcome the practical limitation of a stacked multi-axis frame 86, the challenge then becomes more evenly distributing the mass of the system across the two stages 88, 92 while still providing movement within the x-y plane. In such a system, the amount of mass associated with movement of the abrasive element 72 along the x-axis 90 and along the y-axis 94 may be reduced, thus providing increased processing speeds and greater production rates. In one aspect of the disclosure, this may be achieved by “de-stacking” the stages such that the mass associated with one of the stages is not attributed to the other stage. For example, in an exemplary embodiment, a multi-axis frame for providing movement within a plane (e.g., x-y plane) may include two stages positioned adjacent each other but without either one being mounted on the other. Moreover, each stage may share (e.g., substantially equally) in supporting the mass of the holding plate and abrasive element. Movement of the two stages in a first coordinated manner may be configured to cause movement of the holding plate in a first coordinate direction (e.g., the x-direction) and movement of the two stages in a second coordinated manner may be configured to cause movement of the holding plate in a second coordinate direction (e.g., the y-direction). Various embodiments of multi-axis frames having a non-stacked configuration will now be described.

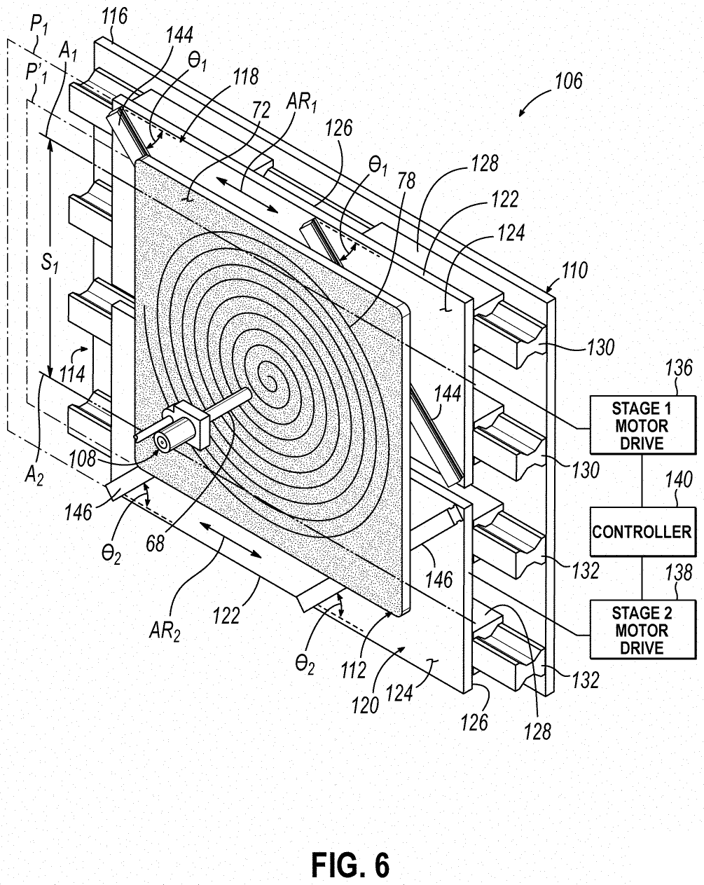

In this regard, FIG. 6 illustrates an apparatus 106 for generating relative movement between a ferrule assembly 68 and an abrasive element 72 to generate an abrasion path 78 on the abrasive element 72, and thereby polish the mating interface 70 of the ferrule assembly 68. The apparatus 106 may be configured such that the ferrule assembly 68 is stationary while the abrasive element 72 is moved in a plane, such as an x-y plane, to generate the abrasion path 78. In the embodiment shown, the ferrule assembly 68 is secured to a first mount 108 and the abrasive element 72 is secured to a second mount 110. The second mount 110 includes a holding plate or platen 112 having an upper surface configured to receive the abrasive element 72, which may take the form of an abrasive sheet or film. The second mount 110 is configured to be movable. In this regard, the second mount 110 may include a multi-axis frame 114 for moving the holding plate 112 within the plane. The multi-axis frame 114 includes a base 116 on which is movably mounted a first stage 118 and a second stage 120. Unlike the embodiment described above in reference to FIG. 5, the first and second stages 118, 120 are not stacked one on top of the other but are instead positioned adjacent to each other. For example, the first and second stages 118, 120 may generally lie within the same plane P₁ and be laterally offset from each other. Moreover, there may be no overlap between the first and second stages 118, 120. Thus, the mass of one of the stages 118, 120 is not attributed to the other stage 118, 120. Instead, the mass of each stage is supported directly by the base 116.

The first stage 118 includes a plate-like body 122 having an upper surface 124 and a lower surface 126. The lower surface 126 includes one or more receiving channels or bushings 128 configured to cooperate with one or more guide rails 130 (“first stage guide rails 130”) mounted to the base 116 of the apparatus 106. In the illustrated embodiment, the first stage 118 is movably coupled to two guide rails 130 on the base 116, but the number of guide rails 130 may be fewer or more than that shown in the figure. Moreover, the guide rails 130 may be generally parallel to each other. In this regard, the guide rails 130 constrain movement of the first stage 118 along a first axis A₁ and in both directions defined by that axis, as illustrated by double arrow AR₁. The movement of the first stage 118 along the first axis A₁ maintains the first stage 118 within the plane P₁.

In a similar manner, the second stage 120 includes a plate-like body 122 having an upper surface 124 and a lower surface 126. The lower surface 126 includes one or more receiving channels or bushings 128 configured to cooperate with one or more guide rails 132 (“second stage guide rails 132”) mounted to the base 116 of the apparatus 106. In the illustrated embodiment, the second stage 120 is movably coupled to two guide rails 132 on the base 116, but the number of guide rails 132 may be fewer or more than that shown in the figure. Moreover, the guide rails 132 may be generally parallel to each other. In this regard, the guide rails 132 constrain movement of the second stage 120 along a second axis A₂ and in both directions defined by that axis, as illustrated by double arrow AR₂. The movement of the second stage 120 along the second axis A₂ maintains the second stage 120 within the plane P₁.

In the illustrated embodiment, the first and second stages 118, 120 are configured to move along respective first and second axes A₁, A₂ that are substantially parallel to each other but laterally spaced or separated from each other by a distance S₁. The arrangement shown in FIG. 6 is in contrast to traditional multi-axis frames wherein the two stages are configured to move in directions that are perpendicular to each other, such as in the manner described above in reference to FIG. 5. In addition, the first and second stages 118, 120 are configured to substantially lie within the same plane P₁, which again is in contrast to that shown in FIG. 5. The first stage 118 includes a motor drive 136 for controlling an actuator (not shown) for moving the first stage 118 along the guide rails 130 and back and forth along the first axis A₁. The second stage 120 similarly includes a motor drive 138 for controlling an actuator (not shown) for moving the second stage 120 along the guide rails 132 and back and forth along the second axis A₂. The motor drives 136, 138 may be operatively coupled to a controller 140 for controlling the position of the holding plate 112 (and the abrasive element 72 carried thereby) relative to the ferrule assembly 68 through movement of the first and second stages 118, 120. The controller 140 is generally well known in the art and thus will not be described in further detail herein.

In accordance with one aspect of the disclosure, the multi-axis frame 114 of the apparatus 106 is configured to provide for two degrees of freedom for moving the abrasive element 72 within a plane (e.g., parallel to the P₁ plane) but achieve the two degrees of freedom with stages 118, 120 that are not stacked and that are movable along generally parallel first and second axes A₁, A₂. This may be achieved by movably mounting the holding plate 112 to each of the first and second stages 118, 120 via one or more guide rails 144, 146 (two shown, also referred to simply as “holding plate guide rails 144, 146”). The holding plate 112 includes a plate-like body having an upper surface and a lower surface. The lower surface includes one or more receiving channels or bushings 148 configured to cooperate with the guide rails 144, 146, which are respectively mounted to the upper surfaces 124 of the first and second stages 118, 120. The guide rails 144, 146 are coupled to the respective first and second stages 118, 120 and arranged so as to form an acute angle θ₁, θ₂ relative to the first and second axes A₁, A₂ along which the first and second stages 118, 120 move. Thus, for example, for each of the two guide rails 144 on the first stage 118, the guide rails form an angle θ₁ relative to the first axis A₁. Similarly, for each of the two guide rails 146 on the second stage 120, the guide rails form an angle θ₂ relative to the second axis A₂. In other words, each guide rail 144 on the first stage 118 forms the same angle θ₁ relative to the first axis A₁, and each guide rail 146 on the second stage 120 forms the same angle θ₂ relative to the second axis A₂. In one embodiment, the angles θ₁, θ₂ may be the same. In an alternative embodiment, however, the angles θ₁, θ₂ may be different from each other. This will be explained in more detail below.

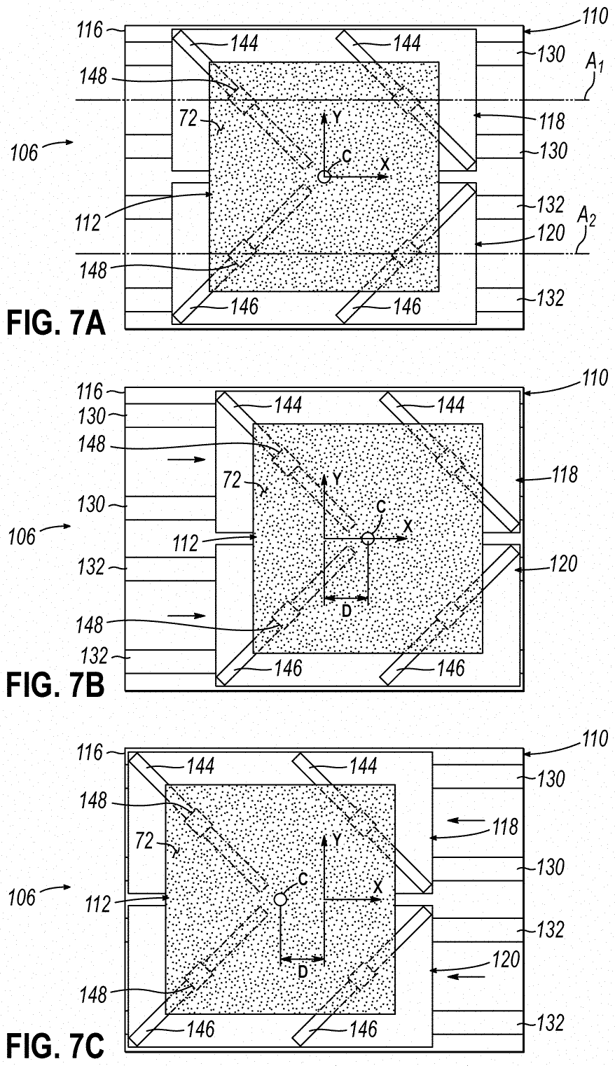

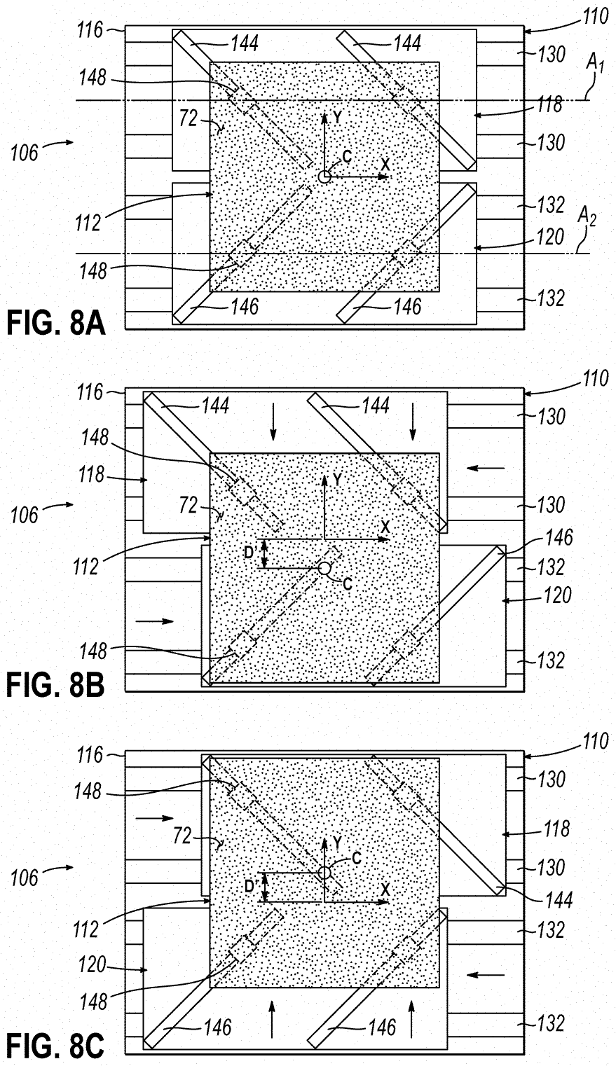

By arranging the guide rails 144, 146 at an angle θ₁, θ₂ relative to the first and second axes A₁, A₂, movement of the first and second stages 118, 120 along the guide rails 130, 132 causes movement of the holding plate 112 within a plane P′₁ and in two orthogonal coordinate directions (e.g., x and y directions). In other words, movement of the two stages 118, 120 along unidirectional axes A₁, A₂ provides for two-dimensional movement of the holding plate 112 within the plane P′₁. FIGS. 7A-8C illustrate in more detail the movement of the holding plate 112 in two dimensions within the plane P₁ based on movement of the first and second stages 118, 120 along their substantially parallel first and second axes A₁, A₂.

FIGS. 7A-7C illustrate the movement of the holding plate 112 in a first coordinate direction. In an exemplary embodiment, the first coordinate direction is substantially parallel to the first and second axes A₁, A₂. For purposes of discussion, an x-y coordinate system has been illustrated in the figures and FIGS. 7A-7C illustrate movement of the holding plate 112 in the x-coordinate direction. As noted above, the x-coordinate direction may be substantially parallel to the first and second axes A₁, A₂ respectively defined by the guide rails 130, 132 on which the first and second stages 118, 120 are respectively mounted. For further purposes of discussion and as illustrated in FIG. 7A, the initial or starting position may be set when the first and second stages 118, 120 are generally centered on their respective guide rails 130, 132. The origin of the x-y coordinate system generally corresponds to the center C of the holding plate 112 (more broadly to the intersection of the guide rails 144, 146, as explained below). As illustrated in FIGS. 7B and 7C, coordinated movement of the first and second stages 118, 120 along the first and second axes A₁, A₂ in the same direction results in movement of the holding plate 112 in the x-coordinate direction. Thus, by way of example, movement of the first and second stages 118, 120 in the positive x-direction by an amount D displaces the holding plate 112 in the positive x-direction by a corresponding amount D (FIG. 7B). Similarly, movement of the first and second stages 118, 120 in the negative x-direction by an amount D displaces the holding plate 112 in the negative x-direction by a corresponding amount D (FIG. 7C). Thus, movement of the first and second stages 118, 120 in the same direction along their respective first and second axes A₁, A₂ moves the holding plate 112 in a first coordinate direction (e.g., the x-direction) within the plane P′₁. Moreover, the amount of displacement D in the ±x-direction corresponds to an equal displacement D of the holding plate 112 in the ±x-direction.

FIGS. 8A-8C illustrate the movement of the holding plate 112 in a second coordinate direction. The second coordinate direction may be substantially perpendicular to the first coordinate direction and the first and second axes A₁, A₂. Again, for purposes of discussion, an x-y coordinate system has been illustrated in the figures and FIGS. 8A-8C illustrate movement of the holding plate 112 in the y-coordinate direction. As noted above, the y-coordinate direction may be substantially perpendicular to the guide rails 130, 132 on which the first and second stages 118, 120 are mounted. For further purposes of discussion and as illustrated in FIG. 8A, the initial or starting position may be set when the first and second stages 118, 120 are generally centered on their respective guide rails 130, 132. Like above, the origin of the x-y coordinate system may generally correspond to the center C of the holding plate 112. As illustrated in FIGS. 8B and 8C, coordinated movement of the first and second stages 118, 120 along the first and second axes A₁, A₂ in opposite directions results in movement of the holding plate 112 in the y-coordinate direction. Thus, by way of example, movement of the first stage 118 in the negative x-direction by an amount D and movement of the second stage 120 in the positive x-direction by an amount D displaces the holding plate 112 in the negative y-direction by an amount D′ (FIG. 8B). Similarly, movement of the first stage 118 in the positive x-direction by an amount D and movement of the second stage 120 in the negative x-direction by an amount D displaces the holding plate 112 in the positive y-direction by an amount D′ (FIG. 8C). Thus, movement of the first and second stages 118, 120 in the opposite direction along their respective parallel first and second axes A₁, A₂, moves the holding plate 112 in a second coordinate direction (e.g., the y-direction) within the plane P₁. Moreover, the amount of displacement D in the ±x-direction corresponds to a displacement D′ in the ±y-direction and may or may not be equal to the displacement D, depending on, for example, the angles θ₁, θ₂ the guide rails 144, 146 make relative to the first and second axes A₁, A₂. This is explained in more detail below.

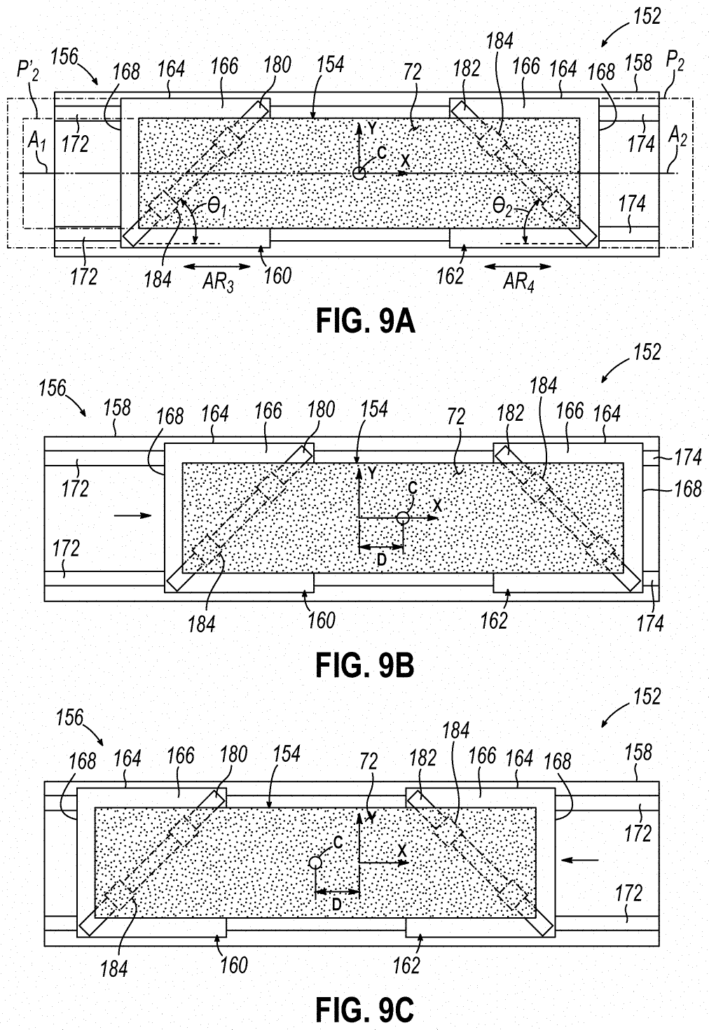

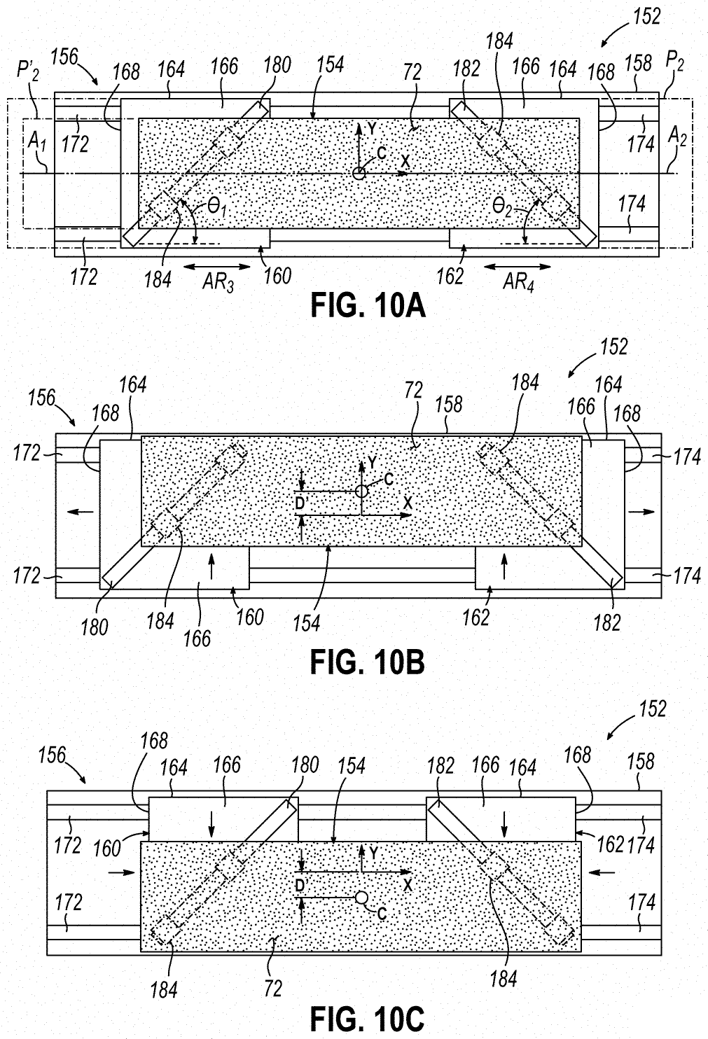

FIGS. 9A-10C illustrate a second mount 152 in accordance with an alternative embodiment of the disclosure. The second mount 152 may, for example, be used in the apparatus 106 described above in reference to FIG. 6 or some other similar apparatus. The second mount 152 includes a holding plate or platen 154 having an upper surface configured to receive the abrasive element 72, which may take the form of an abrasive sheet or film. The second mount 152 may include a multi-axis frame 156 for moving the holding plate 154 within a plane, such as an x-y plane. The multi-axis frame 156 includes a base 158 on which is movably mounted a first stage 160 and a second stage 162. Similar to the embodiment described above, the first and second stages 160, 162 are not stacked one on top of the other but are instead positioned adjacent to each other. For example, the first and second stages 160, 162 may generally lie within the same plane P₂ but may be laterally offset from each other. Moreover, there may be no overlap between the two stages 160, 162. Thus, the mass of one of the stages 160, 162 is not attributed to the other stage 118, 120. Instead, the mass of each stage is supported directly by the base 158.

The first stage 160 includes a plate-like body 164 having an upper surface 166 and a lower surface 168. The lower surface 168 includes one or more receiving channels or bushings (not shown) configured to cooperate with a one or more guide rails 172 mounted to the base 158 of the multi-axis frame 156 (e.g., such as a body of the apparatus 106). In the illustrated embodiment, the first stage 160 is movably coupled to two guide rails 172 (“first stage guide rails 172”) on the base 158, but the number of guide rails 172 may be fewer or more than that shown in the figure. Moreover, the guide rails 172 may be generally parallel to each other. In this regard, the guide rails 172 constrain movement of the first stage 160 along a first axis A₁ and in both directions defined by that axis, as illustrated by double arrow AR₃. The movement of the first stage 160 along the first axis A₁ maintains the first stage 160 within the plane P₂.

In a similar manner, the second stage 162 includes a plate-like body 164 having an upper surface 166 and a lower surface 168. The lower surface 168 includes one or more receiving channels or bushings (not shown) configured to cooperate with one or more guide rails 174 mounted to the base 158 of the multi-axis frame 156 (e.g., such as a body of the apparatus 106). In the illustrated embodiment, the second stage 162 is movably coupled to two guide rails 174 (“second stage guide rails 174”) on the base 116, but the number of guide rails 174 may be fewer or more than that shown in the figure. Moreover, the guide rails 174 may be generally parallel to each other. In this regard, the guide rails 174 constrain movement of the second stage 162 along a second axis A₂ and in both directions defined by that axis, as illustrated by double arrow AR₄. The movement of the second stage 162 along the second axis A₂ maintains the second stage 162 within the plane P₂.

In the illustrated embodiment, the first and second axes A₁, A₂ that the first and second stages 160, 162 are configured to move along are substantially parallel to each other. More specifically, in this embodiment the first and second axes A₁, A₂ may additionally be substantially colinear with each other. Thus, the guide rails 172, 174 may be substantially parallel and colinear with each other. In one exemplary embodiment, each guide rail pair 172, 174 may be a single continuous guide rail, such as illustrated in FIGS. 9A-10C. A discontinuous guide rail arrangement, however, may also be possible. The arrangement shown in FIGS. 9A-10C is in contrast to traditional multi-axis frames wherein the two stages are configured to move in directions that are perpendicular to each other, such as in the manner described above in reference to FIG. 5. In addition, the first and second stages 160, 162 are configured to substantially lie within the same plane P₂, which again is in contrast to that shown in FIG. 5. Although not shown, but similar to the embodiment above shown in FIG. 6, the first stage 160 includes a motor drive for controlling an actuator for moving the first stage 160 along the guide rails 172 and back and forth along the first axis A₁. The second stage 162 similarly includes a motor drive for controlling an actuator for moving the second stage 162 along the guide rails 174 and back and forth along the second axis A₂. The motor drives may be operatively coupled to a controller for controlling the position of the holding plate 154 (and the abrasive element 72 carried thereby) relative to the ferrule assembly 68 through movement of the first and second stages 160, 162.

The multi-axis frame 156 is configured to provide for two degrees of freedom for moving the abrasive element 72 within a plane (e.g., parallel to the P₂ plane) but achieve the two degrees of freedom with first and second stages 160, 162 that are not stacked and that are movable along generally parallel and colinear first and second axes A₁, A₂. This may be achieved by movably mounting the holding plate 154 to each of the first and second stages 160, 162 via one or more guide rails 180, 182 (one shown; also referred to as “holding plate guide rails 180, 182”). The holding plate 154 includes a plate-like body having an upper surface and a lower surface. The lower surface includes one or more receiving channels or bushings 184 configured to cooperate with the guide rails 180, 182, which are respectively mounted to the upper surfaces 124 of the first and second stages 160, 162. More particularly, the guide rails 180, 182 are coupled to the respective first and second stages 160, 162 and arranged so as to form an acute angle θ₁, θ₂ relative to the first and second axes A₁, A₂ along which the first and second stages 160, 162 move. Thus, the guide rail 180 on the first stage 160 forms an angle θ₁ relative to the first axis A₁. Similarly, the guide rail 182 on the second stage 162 forms an angle θ₂ relative to the second axis A₂. In one embodiment, the angles θ₁, θ₂ may be the same. In an alternative embodiment, however, the angles θ₁, θ₂ may be different from each. This will be explained in more detail below.

By arranging the guide rails 180, 182 at an angle θ₁, θ₂ relative to the first and second axes A₁, A₂, movement of the first and second stages 160, 162 along the guide rails 180, 182 causes movement of the holding plate 154 within a plane P′₂ and in two orthogonal coordinate directions (e.g., x and y directions). In other words, movement of the two stages 160, 162 along unidirectional and colinear axes A₁, A₂ provides for two-dimensional movement of the holding plate 154 within the plane P₂. FIGS. 9A-10C illustrate in more detail the movement of the holding plate 154 in two dimensions within the plane P₂ based on movement of the first and second stages 160, 162 along their substantially parallel and colinear first and second axes A₁, A₂.

FIGS. 9A-9C illustrate the movement of the holding plate 154 in a first coordinate direction. In an exemplary embodiment, the first coordinate direction is substantially parallel to the first and second axes A₁, A₂. For purposes of discussion, an x-y coordinate system has been illustrated in the figures and FIGS. 9A-9C illustrate movement of the holding plate 154 in the x-coordinate direction. As noted above, the x-coordinate direction may be substantially parallel to the first and second axes A₁, A₂ respectively defined by the guide rails 172, 174 on which the first and second stages 160, 162 are respectively mounted. For further purposes of discussion, and as illustrated in FIG. 9A, the initial or starting position may be set when the first and second stages 160, 162 are positioned on their respective guide rails 172, 174 so as to permit movement in both directions along the guide rails 172, 174. The origin of the x-y coordinate system may generally correspond to the center C of the holding plate 156. As illustrated in FIGS. 9B and 9C, coordinated movement of the first and second stages 160, 162 along the colinear first and second axes A₁, A₂ in the same direction results in movement of the holding plate 154 in the x-coordinate direction. Thus, by way of example, movement of the first and second stages 160, 162 in the positive x-direction by an amount D displaces the holding plate 154 in the positive x-direction by a corresponding amount D (FIG. 9B). Similarly, movement of the first and second stages 160, 162 in the negative x-direction by an amount D displaces the holding plate 154 in the negative x-direction by a corresponding amount D (FIG. 9C). Thus, movement of the first and second stages 160, 162 in the same direction along their respective first and second axes A₁, A₂ moves the holding plate 154 along a first coordinate direction (e.g., the x-direction) within the plane P′₂. Moreover, the amount of displacement D in the ±x-direction corresponds to an equal displacement D of the holding plate 156 in the ±x-direction.

FIGS. 10A-10C illustrate the movement of the holding plate 154 in a second coordinate direction. The second coordinate direction may be substantially perpendicular to the first coordinate direction and the first and second axes A₁, A₂. Again, for purposes of discussion, an x-y coordinate system has been illustrated in the figures and FIGS. 10A-10C illustrate movement of the holding plate 154 in the y-coordinate direction. As noted above, the y-coordinate direction is substantially perpendicular to the guide rails 172, 174 on which the first and second stages 160, 162 are mounted. For further purposes of discussion and as illustrated in FIG. 10A, the initial or starting position may be set when the first and second stages 160, 162 are positioned on their respective guide rails 172, 174 so as to permit movement in both directions along the guide rails 172, 174. Like above, the origin of the x-y coordinate system may generally correspond to the center C or the holding plate 156. As illustrated in FIGS. 10B and 10C, coordinated movement of the first and second stages 160, 162 along the first and second axes A₁, A₂ in opposite directions results in movement of the holding plate 154 in the y-coordinate direction. Thus, by way of example, movement of the first stage 160 in the negative x-direction by an amount D and movement of the second stage 162 in the positive x-direction by an amount D displaces the holding plate 154 in the positive y-direction by an amount D′ (FIG. 10B). Similarly, movement of the first stage 160 in the positive x-direction by an amount D and movement of the second stage 162 in the negative x-direction by an amount D displaces the holding plate 154 in the negative y-direction by an amount D′ (FIG. 10C). Thus, movement of the first and second stages 160, 162 in the opposite direction along their respective parallel, colinear axes first and second A₁, A₂, moves the holding plate 154 in a second coordinate direction (e.g., the y-direction) within the plane P₂. Moreover, the amount of displacement D in the ±x-direction corresponds to a displacement D′±y-direction which may or may not be equal to the displacement D depending on, for example, the angles θ₁, θ₂ the guide rails 180, 182 make relative to the first and second axes A₁, A₂. This is explained in more detail below.

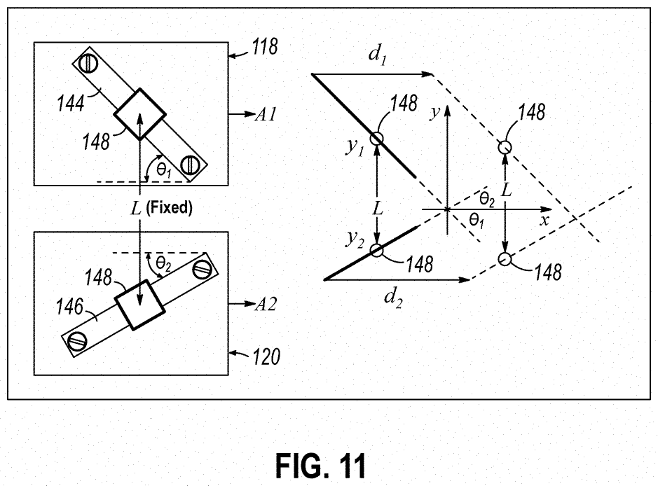

Turning back to the embodiment shown in FIG. 6, as a practical matter, for the controller 140 of the apparatus 106 to control the position of the first and second stages 118, 120 to trace a desired path 78 on the abrasive element 72, there needs to be a mapping between the displacements d₁, d₂ (both positive and negative) along the respective first and second axes A₁, A₂ and the position of the holding plate 112 in the x-y coordinate plane. This mapping may be accomplished using several geometric and algebraic concepts. FIG. 11 illustrates a conceptual rendering of the geometry shown in FIG. 6 for determining the mapping between displacements of the first and second stages (d₁,d₂) and the position of the holding plate 112 in the x-y coordinate plane (x,y). The first stage 118 has a guide rail 144 that forms a first angle θ₁ with the first axis A₁. The second stage 120 has a guide rail 146 that forms a second angle θ₂ with the second axis A₂. In the analysis, these angles are arbitrary. The first stage 118 is displaced along the first axis A₁ by an arbitrary distance d₂. Similarly, the second stage 120 is displaced along the second axis A₂ by an arbitrary distance d₁. The origin of the x-y coordinate system may arbitrarily be set at the intersection of the first and second rails 144, 146 when there is no displacement of the first and second stages 118, 120 along their respective first and second axes A₁, A₂, i.e., when d₁=d₂=0.

For an arbitrary displacement of the first stage 118, the equation of the rail 144 is given by:

y₁(x)=−tan(θ₁)(x−d₁). (1)

For an arbitrary displacement of the second stage 120, the equation of the rail 146 is given by:

y₂(x)=−tan(θ₂)(x−d₂). (2)

The distance S between the rails 144, 146 at any point x is given by:

S(x)=y₂(x)−y₁(x). (3)

At the location of the bearings, the distance between the two is fixed by a distance L. Thus, in other words:

S(x_{bearing})=y₂(x_{bearing})−y₁(x_{bearing})=L. (4)

Substituting equations (1) and (2) into equation (4) and solving for x_{bearing}, one arrives at the following equation:

$${x}_{bearing} ( {d}_{1} , {d}_{2} ) = \frac{{d}_{1} tan ( {θ}_{1} ) + {d}_{2} tan ( {θ}_{2} ) - L}{tan ( {θ}_{1} ) + tan ( {θ}_{2} )} . \qquad ( 5 )$$

If one designates X as the net displacement of the line L and the bearings in the x-direction, then the position of this line may be provided by:

X(d₁,d₂)=x_{bearing}(d₁,d₂)−x_{bearing}(0,0). (6)

Using equation (5) from above, this equation may be simplified to the following:

$$X ( {d}_{1 ,} {d}_{2} ) = \frac{{d}_{1} tan ( {θ}_{1} ) + {d}_{2} tan ( {θ}_{2} )}{tan ( {θ}_{1} ) + tan ( {θ}_{2} )} . \qquad ( 7 )$$

Turning now to the y-direction, if one designates Y as the net displacement of the line L and the bearings in the y-direction, then using either equation (1) or equation (2), the position of this line may be provided by:

Y(d₁,d₂)=y₁[x_{bearing}(d₁,d₂)]−y₁[x_{bearing}(0,0)]. (8)

Substituting from equation (5) above and after much simplification, one arrives at the following equation:

$$Y ( {d}_{1} , {d}_{2} ) = \frac{tan ( {θ}_{1} ) tan ( {θ}_{2} )}{tan ( {θ}_{1} ) + tan ( {θ}_{2} )} ( {d}_{1} - {d}_{2} ) . \qquad ( 9 )$$

Thus, by way of summary, if the two stages 118, 120 with rails 144, 146 angled at θ₁, θ₂ respectively are displaced by an amount d₁, and d₂ along their respective first and second axes A₁, A₂, then the holding plate 112, which is fixedly secured to the bearings, will be displaced in the x-y plane according to:

$$[ \begin{matrix}X \\ Y\end{matrix} ] = [ \begin{matrix}\frac{tan ( {θ}_{1} )}{tan ( {θ}_{1} ) + tan ( {θ}_{2} )} & \frac{tan ( {θ}_{2} )}{tan ( {θ}_{1} ) + tan ( {θ}_{2} )} \\ \frac{tan ( {θ}_{1} ) tan ( {θ}_{2} )}{tan ( {θ}_{1} ) + tan ( {θ}_{2} )} & - \frac{tan ( {θ}_{1} ) tan ( {θ}_{2} )}{tan ( {θ}_{1} ) + tan ( {θ}_{2} )}\end{matrix} ] [ \begin{matrix}{d}_{1} \\ {d}_{2}\end{matrix} ] . \qquad ( 10 )$$

As noted above, in many cases, the (X,Y) values will be the known values and the (d₁, d₂) will need to be determined as a practical matter for controlling the movement of the first and second stages 118, 120 in order to generate the desired abrasion path 78. Because the coefficient matrix is invertible, equation (10) may be rearranged as:

$$[ \begin{matrix}{d}_{1} \\ {d}_{2}\end{matrix} ] = [ \begin{matrix}1 & \frac{1}{tan ( {θ}_{1} )} \\ 1 & - \frac{1}{tan ( {θ}_{2} )}\end{matrix} ] [ \begin{matrix}X \\ Y\end{matrix} ] . \qquad ( 11 )$$

Thus, equation (11) represents a mapping between the (x,y) domain and the (d₁, d₂) domain.

In the analysis above, it might be useful to further examine a few special cases. By way of example, one might want to take a look at the case where the angles θ₁, θ₂ are equal to each other. In that case, equation (10) simplifies to the following:

$$[ \begin{matrix}X \\ Y\end{matrix} ] = [ \begin{matrix}\frac{1}{2} & \frac{1}{2} \\ \frac{tan ( {θ}_{1} )}{2} & - \frac{tan ( {θ}_{1} )}{2}\end{matrix} ] [ \begin{matrix}{d}_{1} \\ {d}_{2}\end{matrix} ] . \qquad ( 12 )$$

Another interesting case may also be provided when the angles θ₁, θ₂ are equal to 45 degrees. In that special case, equation (12) further simplifies to:

$$[ \begin{matrix}X \\ Y\end{matrix} ] = [ \begin{matrix}\frac{1}{2} & \frac{1}{2} \\ \frac{1}{2} & - \frac{1}{2}\end{matrix} ] [ \begin{matrix}{d}_{1} \\ {d}_{2}\end{matrix} ] . \qquad ( 13 )$$

The equations provided above are valid for arbitrary displacements d₁, d₂ of the first and second stages 118, 120 along their respective first and second axes A₁, A₂. Another special case may be provided when the first and second stages 118, 120 are displaced in the same direction by an equal amount D, i.e., d₁=d₂=D. In that case, equation (10) simplifies to the following:

$$[ \begin{matrix}X \\ Y\end{matrix} ] = [ \begin{matrix}D \\ 0\end{matrix} ] . \qquad ( 14 )$$

In other words, the holding plate 112 moves in the x-direction by an amount D. If D is positive, the holding plate 112 moves in the positive x-direction, as demonstrated in FIG. 7B. If D is negative, the holding plate 112 moves in the negative x-direction, as demonstrated in FIG. 7C. It is interesting to note that equation (14) is completely independent of the angles θ₁, θ₂ the guide rails 144, 146 make relative to the first and second axes A₁, A₂. Thus, the behavior dictated by equation (14) is consistent with what we would expect from the physical system shown in FIG. 6.

In a further special case, the first and second stages 118, 120 are displaced in opposite directions by an equal amount D, i.e., d₁=D; d₂=−D. In that case, equation (10) simplifies to the following:

$$[ \begin{matrix}X \\ Y\end{matrix} ] = [ \begin{matrix}\frac{tan ( {θ}_{1} ) - tan ( {θ}_{2} )}{tan ( {θ}_{1} ) + tan ( {θ}_{2} )} D \\ \frac{2 tan ( {θ}_{1} ) tan ( {θ}_{2} )}{tan ( {θ}_{1} ) + tan ( {θ}_{2} )} D\end{matrix} ] . \qquad ( 15 )$$

If the angles θ₁, θ₂ are equal to each other, i.e., the guide rails 144, 146 form the same angle relative to the first and second axes A₁, A₂, then equation (15) further reduces to:

$$[ \begin{matrix}X \\ Y\end{matrix} ] = [ \begin{matrix}0 \\ D tan ( {θ}_{1} )\end{matrix} ] . \qquad ( 16 )$$

In this case, there is no net movement of the holding plate 112 in the x-direction but only in the y-direction. The amount of displacement in the y direction is some fraction of the displacement D of the first and second stages 118, 120 in opposite directions. That fraction is dependent upon the angle that the guide rails 144, 146 make relative to the first and second axes A₁, A₂. In the event that the guide rails 144, 146 are at a 45 degrees angle, then equation (16) further reduces to:

$$[ \begin{matrix}X \\ Y\end{matrix} ] = [ \begin{matrix}0 \\ D\end{matrix} ] . \qquad ( 17 )$$

In other words, at 45 degrees a displacement of the first and second stages 118, 120 in opposite directions by an amount D results in the holding plate 112 moving only in the y-direction by the same amount D. Displacing the first and second stages 118, 120 in the manner shown in FIG. 8B results in the holding plate 112 moving in the negative y-direction by an amount D. Displacing the first and second stages 118, 120 in the manner shown in FIG. 8C results in the holding plate 112 moving in the positive y-direction by an amount D.

The mapping outlined above for the embodiment shown in FIG. 6 may be readily determined for other geometries, such as that shown in FIGS. 9A-10C. In this way, for a desired abrasion path 78 for which values are known relative to a coordinate system, such as a Cartesian coordinate system, the displacement of the first and second stages on their respective angled guide rails may be determined. Thus, the controller is able to move the stages so as to trace the desired path 78 on the abrasive element 72. As mentioned above, the desired path 78 may be a spiral path 78 on the abrasive element 72. Applicant's prior application entitled “METHOD OF PROCESSING A FERRULE AND APPARATUS FOR CARRYING OUT THE METHOD,” filed on Jun. 29, 2018 and having U.S. Provisional Application Ser. No. 62/692,642, the disclosure of which is incorporated by reference herein in its entirety, disclosed a method for processing the ferrule by tracing a spiral path on the abrasive element. Embodiments of the disclosure are not limited to a spiral abrasion path 78, and other abrasion paths, such as a circle or a figure-8, may be used.

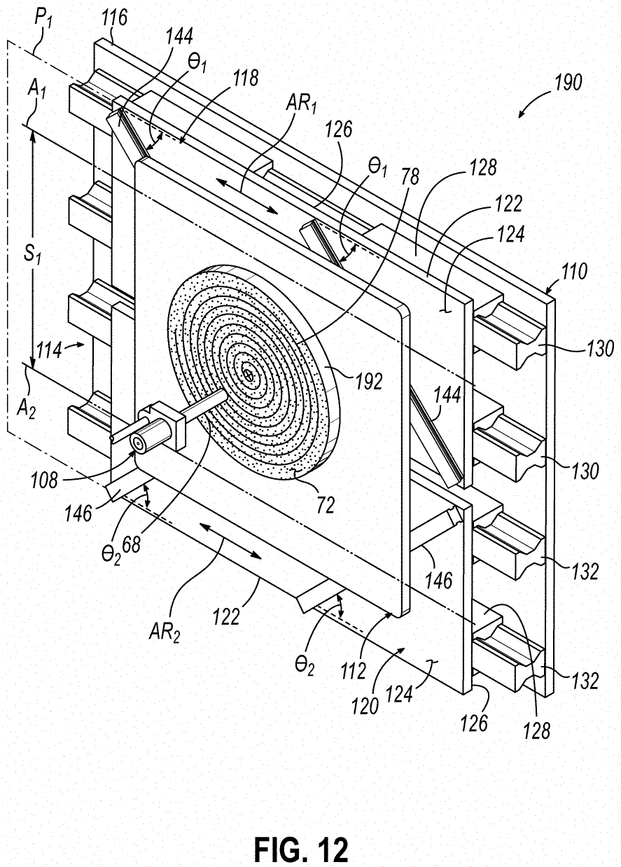

FIG. 12 illustrates an alternative embodiment in accordance with the disclosure. FIG. 12 illustrates an apparatus 190 similar to that shown in FIG. 6, wherein like reference numbers refer to similar features. The primary difference between the apparatus 106 shown in FIG. 6 and the apparatus 190 shown in FIG. 12 is that the holding plate 112 includes a spindle 192. Applicant's prior application entitled “APPARATUS FOR PROCESSING A FERRULE AND ASSOCIATED METHOD,” filed on Aug. 31, 2018 and having U.S. Provisional Application Ser. No. 62/725,595, the disclosure of which is incorporated by reference herein in its entirety, disclosed an apparatus having a first mount to which a ferrule or ferrule assembly is mounted and a second mount having a multi-axis frame. A rotatable spindle is mounted to the multi-axis frame and the abrasive element is carried by the spindle (e.g., see FIG. 15 of Applicant's prior application). In that disclosure, the multi-axis frame is of the stacked type. FIG. 12 of the present application is similar to the apparatus disclosed in Applicant's prior application, but the multi-axis frame is replaced with the non-stacked multi-axis frame 114 disclosed herein. The apparatus 190 using multi-axis frame 114 and including spindle 192 would operate in much the same manner as described in Applicant's prior application.

Those skilled in the art will appreciate that other modifications and variations can be made without departing from the spirit or scope of the invention. For example, although the ferrule assemblies 68 are described above as being supported by respective connector bodies (e.g., the connector body 24 in FIG. 1) of fiber optic connectors during the processing, in alternative embodiments the ferrule assemblies may be processed before being assembled together with a respective connector body. Moreover, in some embodiments, the ferrule assemblies may not be intended for use in fiber optic connectors, but instead for other optical components, such as as attenuators, optical couplers, isolators, collimators, filters, switches, wavelength division multiplexing (WDM) modules, etc. Furthermore, although the multi-axis frame is described herein in the context of processing ferrules or ferrule assemblies, the multi-axis frame may find benefits in applications where a general workpiece is to be moved around within a plane during, for example, processing of the workpiece. Since modifications, combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. An apparatus for processing a ferrule with an abrasive element, the apparatus comprising:
a first mount configured to secure the ferrule;
a second mount including a holding plate configured to secure the abrasive element and a multi-axis frame supporting the holding plate, the multi-axis frame being configured to move the holding plate within a plane; and
a controller operatively coupled to the multi-axis frame for controlling the movement of the holding plate,
wherein the multi-axis frame comprises:
a first stage movable along a first axis; and
a second stage movable along a second axis that is substantially parallel to the first axis.

2. The apparatus of claim 1, wherein the multi-axis frame further comprises a base, and wherein the first and second stages are movably coupled to the base independently from each other.

3. The apparatus of claim 1, wherein support for the holding plate is shared between the first and second stages such that neither of the first or second stages supports an entire mass of the holding plate.

4. The apparatus of claim 1, wherein movement of the first and second stages in a same direction along their respective first and second axes causes the holding plate to move in a first direction within the plane, and movement of the first and second stages in opposite directions along their respective first and second axes causes the holding plate to move in a second direction within the plane, the second direction being different than the first direction.

5. The apparatus of claim 4, wherein the first direction is generally parallel to the first and second axes.

6. The apparatus of claim 4, wherein the second direction is substantially perpendicular to the first direction.

7. The apparatus of claim 1, wherein the first and second axes are substantially colinear with each other.

8. The apparatus of claim 2, wherein:
the first stage is movably coupled to the base by one or more first stage guide rails:
the second stage is movably coupled to the base by one or more second stage guide rails, and
wherein the one or more first stage guide rails extend in a direction substantially parallel to the first axis and the one or more second stage guide rails extend in a direction substantially parallel to the second axis.

9. The apparatus of claim 8, wherein the one or more first guide rails and the one or more second guide rails are colinear and collectively form a corresponding one or more continuous guide rails.

10. The apparatus of claim 1, wherein the holding plate is movably coupled to the first stage by one or more first holding plate guide rails, and wherein the holding plate is movably coupled to the second stage by one or more second holding plate guide rails.

11. The apparatus of claim 10, wherein the one or more first holding plate guide rails are arranged at a first angle relative to the first axis.

12. The apparatus of claim 11, wherein the one or more second holding plate guide rails are arranged at a second angle relative to the second axis.

13. The apparatus of claim 12, wherein the first angle and the second angle are substantially equal.

14. The apparatus of claim 13, wherein the first and second angle are substantially equal to about 45°.

15. The apparatus of claim 12, wherein the first angle and the second angle are different from each other.

16. The apparatus of claim 1, wherein the first mount is stationary.

17. The apparatus of claim 1, wherein the holding plate further includes a rotatable spindle, the abrasive element being configured to be secured to the spindle.

18. The apparatus of claim 1, wherein the controller is configured to cause relative movement between the first mount and the second mount such that engagement of the ferrule with the abrasive element during the relative movement traces a path in the abrasive element.

19. The apparatus of claim 18, wherein the path is selected from the group consisting of a circle, a figure-8, or a spiral.

20. The apparatus of claim 1, wherein a ferrule assembly comprises the ferrule and at least one optical fiber coupled to the ferrule, and wherein the apparatus is configured for processing the ferrule assembly with the abrasive element.

21. A method of processing a ferrule that includes an end face, the method comprising:
holding the ferrule stationary;
engaging the end face of the ferrule with the abrasive element; and
moving the abrasive element relative to the ferrule within a plane to trace an abrading path on the abrasive element,
wherein the abrasive element is coupled to a multi-axis frame that includes a first stage and a second stage, the moving step further comprising:
moving the first stage along a first axis; and
moving the second stage along a second axis parallel to the first axis to move the abrasive element relative to the ferrule within the plane.

22. The method of claim 21, further comprising moving the first and second stages along their respective first and second axes in a same direction to move the abrasive element in a first direction.

23. The method of claim 22, wherein the first direction is substantially parallel to the first and second axes.

24. The method of claim 22, further comprising moving the first and second stages along their respective first and second axes in opposite directions to move the abrasive element in a second direction, the second direction being different than the first direction.

25. The method of claim 24, wherein the second direction is substantially perpendicular to the first direction.

26. The method of claim 21, further comprising rotating the abrasive element about a central axis during movement of the abrasive element within the plane using the multi-axis frame.

27. The method of claim 21, further comprising tracing a circular path, a figure-8 path, or a spiral path in the abrasive element due to the relative movement between the ferrule and the abrasive element.

28. The method of claim 21, wherein a ferrule assembly comprises the ferrule and at least one optical fiber coupled to the ferrule, and wherein the engaging and moving steps are performed with the ferrule assembly.

29. An apparatus for processing a workpiece, the apparatus comprising:
a multi-axis frame for moving the workpiece within a plane, the multi-axis frame comprising:
a base;
a first stage coupled to the base and movable along a first axis;
a second stage coupled to the base independently from the first stage and movable along a second axis, wherein the first and second axes are substantially parallel to each other; and
a holding plate movably coupled to each of the first and second stages, wherein movement of the first and second stages in a same direction along their respective first and second axes causes the holding plate to move in a first direction within a plane, and wherein movement of the first and second stages in opposite directions along their respective first and second axes causes the holding plate to move in a second direction within the plane, the second direction being different than the first direction.

30. The apparatus of claim 29, wherein the first direction is generally parallel to the first and second axes.

31. The apparatus of claim 29, wherein the second direction is substantially perpendicular to the first direction.
